(19) United States
(12) Patent Application Publication
(10) Pub. No.: US 2004/0217126 A1
(43) Pub. Date: Nov. 4, 2004

(54) Spout assembly for liquid container

(76) Inventor: Jung-Min Lee, Seoul (KR)

Correspondence Address: BRUCE LONDA, NORRIS, MCLAUGHLIN & MARCUS, P.A., 220 EAST 42ND STREET, 30TH FLOOR, NEW YORK, NY, 10017, US

(21) Appl. No.: 10/488,127

(22) PCT Filed: Aug. 23, 2002
(86) PCT No.: PCT/KR02/01590

(30) Foreign Application Priority Data
Aug. 27, 2001 (KR) 2001/53051
Sep. 6, 2001 (KR) 2001/54922
Sep. 6, 2001 (KR) 2001/54924
Sep. 10, 2001 (KR) 2001/56619
Sep. 10, 2001 (KR) 2001/56618
Sep. 28, 2001 (KR) 2001/61560
Sep. 29, 2001 (KR) 2001/61558

(51) Int. Cl. B67D 1/00

(52) U.S. Cl. 222/78; 222/105; 222/464.1; 222/464.3

(57) ABSTRACT

A spout assembly includes a spouting portion, an attaching portion for attaching on a pouch container, the attaching portion integrally extending from the spouting portion, and a spouting guide portion for easily spouting the contents out of the container, the spouting guide portion being disposed in the pouch container. The spouting guide portion includes a specifically designed portion representing goods, information, or esthetic sense.

### TECHNICAL FIELD

The present invention relates to a spout assembly for a liquid container and, more particularly, to a spout assembly that is designed having a specific shape that can transfer a specific image or information, thereby improving the valuation of the product where the spout is applied.

The present invention further relates to a spout assembly for a liquid container, which is designed to be easily located on the sealing portion of the pouch,

### BACKGROUND ART

Korean Utility Model No. 1991-5740 discloses a spout assembly for a pouch container.

Such a spout assembly includes a pouring portion on which a cap is mounted, a sealing portion attached on the pouch container, and a conduit communicating with the pouring portion to discharge the content.

In the conventional spout assembly, the sealing portion is sealed on the pouch container by a thermal process in a state where it is located on a pouch-sealing portion predetermined on the pouch container.

However, when locating the seal portion of the spout assembly on the pouch-sealing portion, since there is not guide means, it is difficult to easily locate the sealing portion on the pouch-sealing portion. As a result, during the locating process of the spout assembly on the pouch-sealing portion, the pouch-sealing portion can be damaged.

In recent years, transparent pouch containers have been increasingly used for users who want to identify the contents filled in the pouch. However, when such transparent pouch containers are used, the simple shape of the spout assembly shown through the transparent pouch container deteriorates the overall esthetic sense of the pouch container.

In addition, since the conventional spout assembly is not designed to be foldable, it has a limitation in packaging the pouch containers.

### DISCLOSURE OF INVENTION

Therefore, the present invention has been made in an effort to solve the above-described problems of the prior art.

It is a first objective of the present invention to provide a spout assembly that is designed to be precisely and easily inserted into a pouch sealing portion, thereby improving the productivity and reducing the inferiority.

It is a second objective of the present invention to provide a spout assembly that is designed having a specific shape capable of transferring a message or illustrating a characteristic of products where the spout assembly is applied, thereby improving the overall esthetic sense of the products.

It is a third objective of the present invention to provide a spout assembly that is designed to be foldable, thereby making it easy to packaging the products where the spout assembly is employed.

To achieve the above objectives, the present invention provides a spout assembly for a pouch container, comprising a sealing portion to be sealed on the pouch container; a spouting portion extending from the sealing portion upward, the spouting portion being provide with a spouting hole; and a spouting guide portion extending from the sealing portion downward, wherein the spouting guide portion comprises a specifically shaped portion that can represent a characteristic of a products and other information and improve an esthetic sense.

Preferably, the specifically shape portion is formed in at least one shape selected from the group consisting of letters, characters, miniatures, and logos.

Preferably, the spouting guide portion is integrally or separately formed with the sealing portion.

The spout assembly further comprises bending means for bending the spouting guide portion at a predetermined angle.

Preferably, the bending means comprises a fixing projection formed extending from the sealing portion, an operation projection selectively engaged with the fixing projection to maintain the bending angle of the spouting guide portion, and an operation projection supporting portion extending from the sealing portion to support the fixing projection.

Preferably, the spout assembly further comprises an insertion guide portion formed under the sealing portion to guide the insertion of the sealing portion onto a pouch-sealing portion of the pouch container, and the insertion guide portion has a width that is reduced as it goes away from the sealing portion.

In addition, the spouting guide portion is enclosed by a nontoxic envelope and a cap is integrally or separately formed on the spouting portion.

### BRIEF DESCRIPTION OF THE DRAWINGS

FIG. 1a is a perspective view of a spout assembly for a pouch container according to a first embodiment of the present invention;

FIGS. 2 to 5 are views illustrating a variety of modified examples of the first embodiment;

FIG. 6 is a partly cut-away perspective view of a pouch container where a spout assembly of the present invention is employed;

FIG. 7 is a perspective view of a spout assembly according to a second embodiment of the present invention;

FIG. 8 is a sectional view of a modified example of the second embodiment;

FIG. 9 is a front view of a spout assembly for a pouch container according to a third embodiment of the present invention;

FIG. 10 is a front view of a spout assembly for a pouch container according to a fourth embodiment of the present invention;

FIG. 11 is a view illustrating a modified example of the fourth embodiment;

FIG. 12 is a front view of a spout assembly for a pouch container according to a fifth embodiment of the present invention;

FIG. 13 is a front view of a spout assembly for a pouch container according to a sixth embodiment of the present invention;

FIG. 14 is a view illustrating an inserting operation of a spout assembly of the present invention into a sealing portion of a pouch container;

FIG. 15 is a front view of a spout assembly for a pouch container according to a seventh embodiment of the present invention; and

FIG. 16 is a front view of a spout assembly for a pouch container according to an eighth embodiment of the present invention, where a spouting guide portion is separated from the spout assembly and disposed in the pouch container.

### BEST MODE FOR CARRYING OUT THE INVENTION

Preferred embodiments of the present invention will be described more in detail hereinafter in conjunction with the accompanying drawings.

A pouch container is made of a material such a laminated film having generally flexible characteristic.

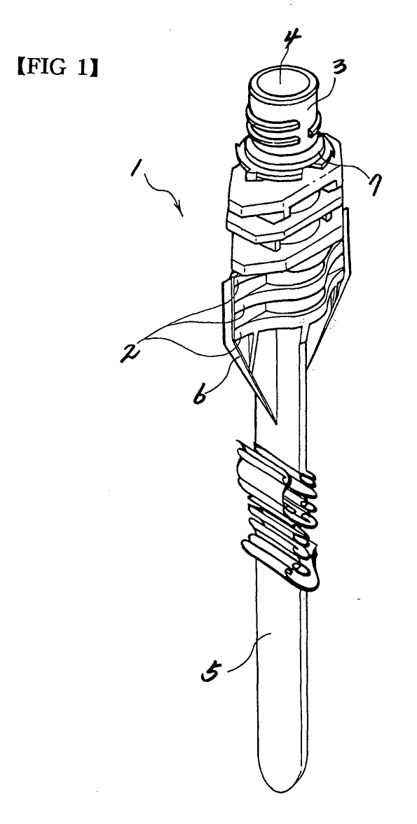

FIG. 1 shows a spout assembly according to a first embodiment of the present invention.

As shown in the drawing, the inventive spout assembly comprises a sealing portion 2 to be sealed on the pouch container, a spouting portion 3 extending from the sealing portion 2 upward, the spouting portion being provide with a spouting hole 4, and a spouting guide portion 5 extending from the sealing portion 3 downward. In addition, to prevent the spouting portion 3 from being polluted, a seal projection is formed on the spouting portion 3 that is engaged with a seal groove formed on a cap to prevent foreign particles from introducing into the spouting portion when the cap is closed on the cap.

In the above-described spout assembly 1, an inserting guide portion 6 is formed between the sealing portion 2 and the spouting guide portion 5.

The inserting guide portion 6 is designed such that its width is reduced at it goes downward, thereby being smoothly inserted.

In addition, the spouting guide portion 5 is at least partly designed having a specific shape or advertising information such as a character, a miniature, a logo, and other advertising letters so that the user can feel an improved aesthetic sense or receive other information from the spouting guide portion.

In this embodiment depicted in FIG. 1, a shape representing a trademark of a company is formed on a part of the spouting guide portion, thereby improving the recognition of the trademark.

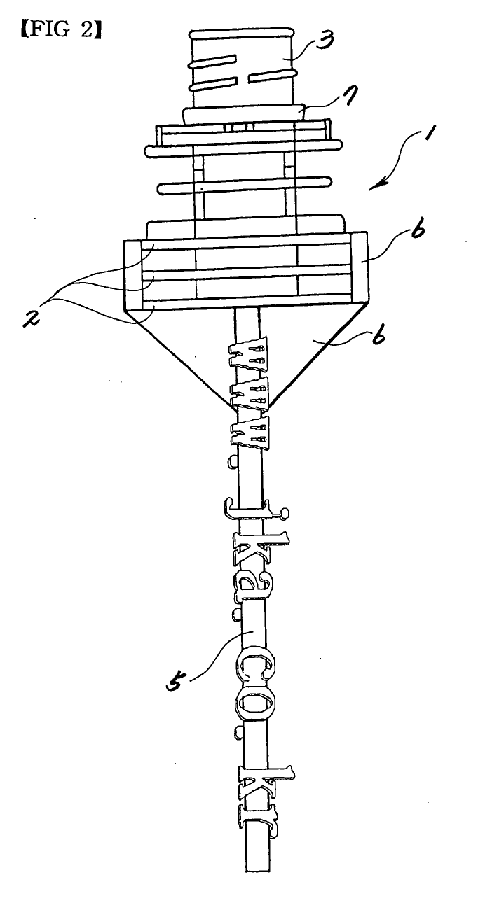

FIG. 2 is a modified example of FIG. 1, in which a homepage address is formed on the spouting guide portion to transfer the homepage information to the user.

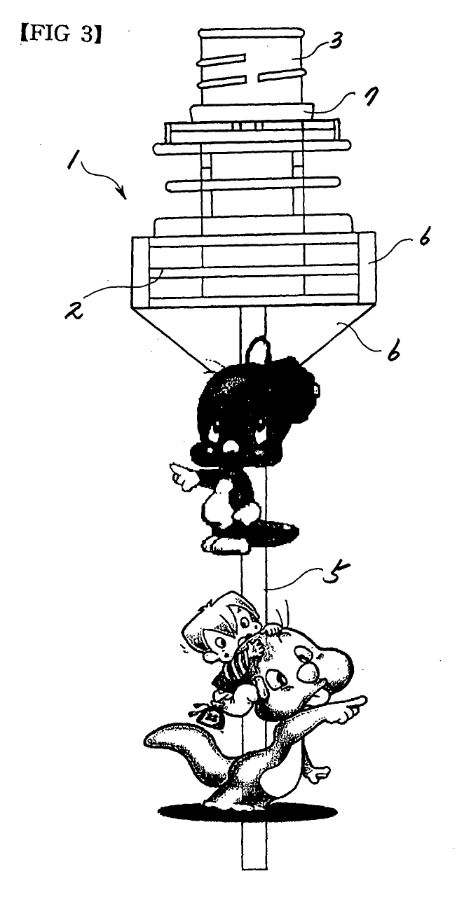

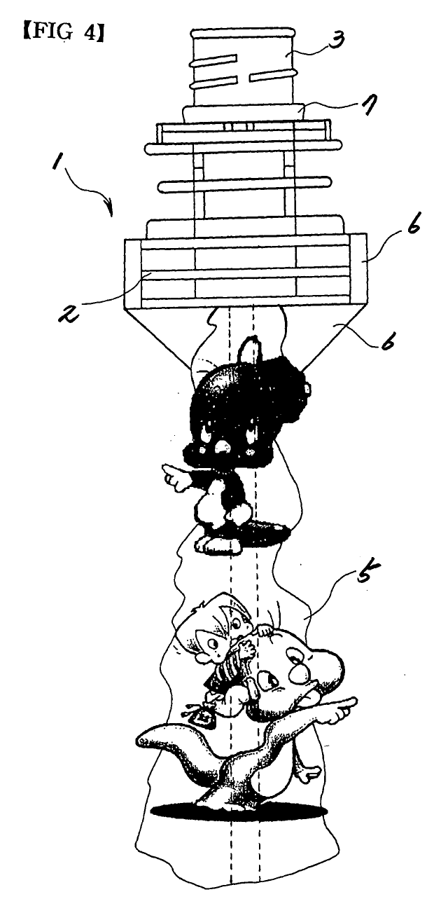

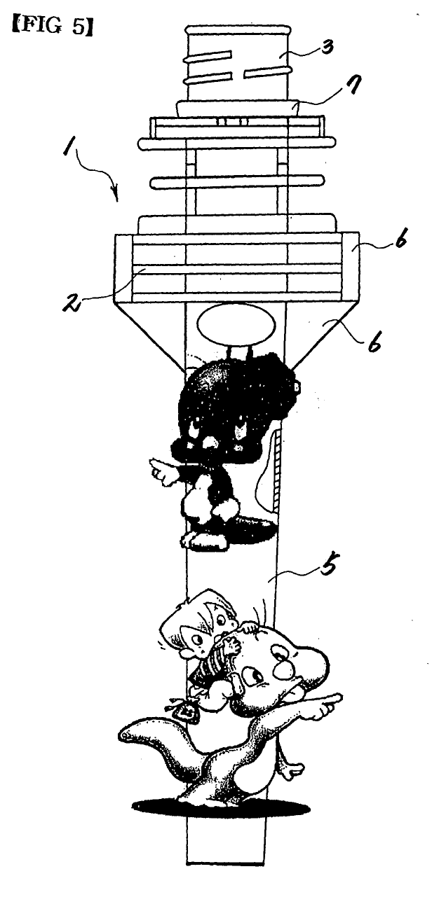

FIGS. 3 to 5 are modified examples of FIG. 1, in which specific characters providing a favorable impression are formed on the spouting guide portions.

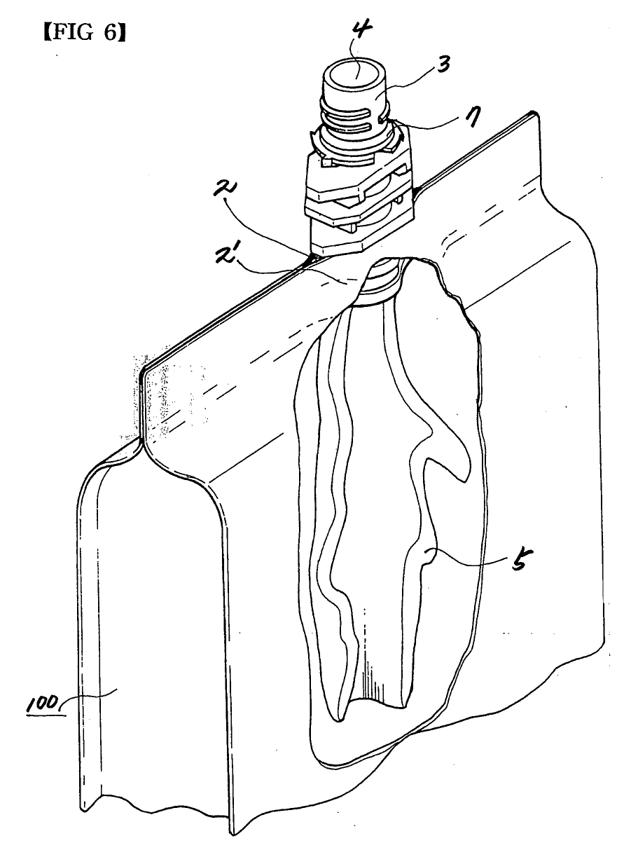

FIG. 6 shows a pouch container where a spout assembly of the present invention is provided.

As shown in the drawing, in a state where the spout-sealing portion 2 is located on a pouch sealing portion 2′ of the pouch container 100, the spout-sealing portion 2 and the pouch sealing portion 2′ are sealed each other by a thermal processing.

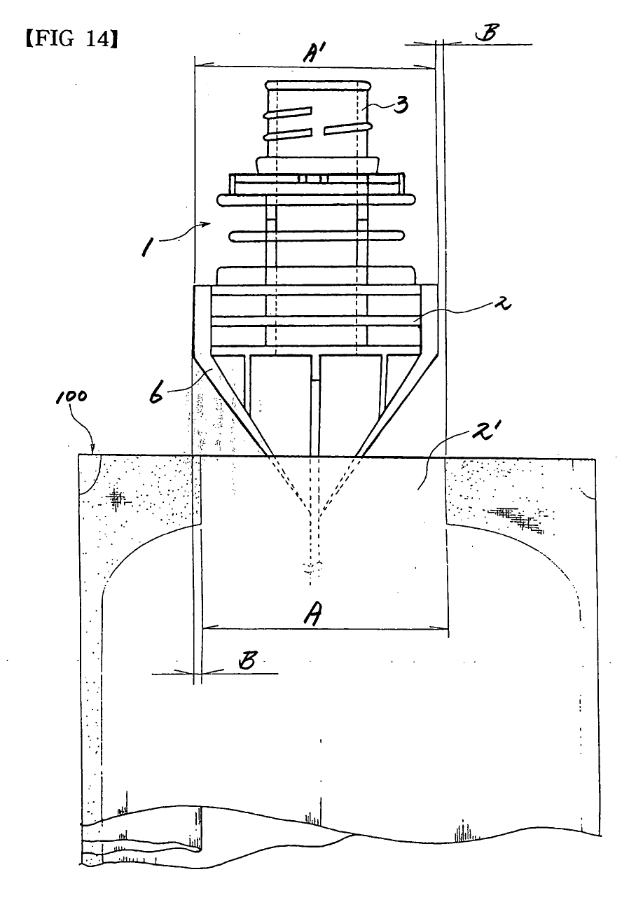

A locating process of the spout-sealing portion 2 of the spout assembly 1 on the pouch sealing portion 2′ will be described more in detail in conjunction with FIG. 14.

In a state where the spout assembly 1 is located on an inlet of the pouch sealing portion 2′ having an insertion width A, it is difficult to accurately identify the spout-sealing portion 2 having the width A′ to the pouch sealing portion 2′ during the insertion process. That is, during the insertion process, there may be some offset between the pouch sealing portion 2′ and the spout-sealing portion 2.

That is, an amount of the offset can be a width B. However, the spout assembly 1 is provided with the insertion guide portion 6 formed between the spout-sealing portion 2 and the spouting guide portion 5. The insertion guide portion 6 is designed having a width that is reduced as it goes downward. That is, the uppermost width of the insertion guide portion 6 is identical to that of the spout-sealing portion 2 and the lowermost width of the insertion guide portion 6 is identical to that of the spouting guide portion 5. As a result, as the spout assembly 1 is inserted into the pouch sealing portion 2′, the offset is compensated by the insertion guide portion 5, thereby making it easy for the spout-sealing portion 2 to be located on the pouch sealing portion 2′.

As described above, in a state where the spout-sealing portion 2 is smoothly located on the pouch sealing portion 2′, the spout-sealing portion 2 is sealed on the pouch sealing portion 2′ of the pouch container 100 through a thermal process.

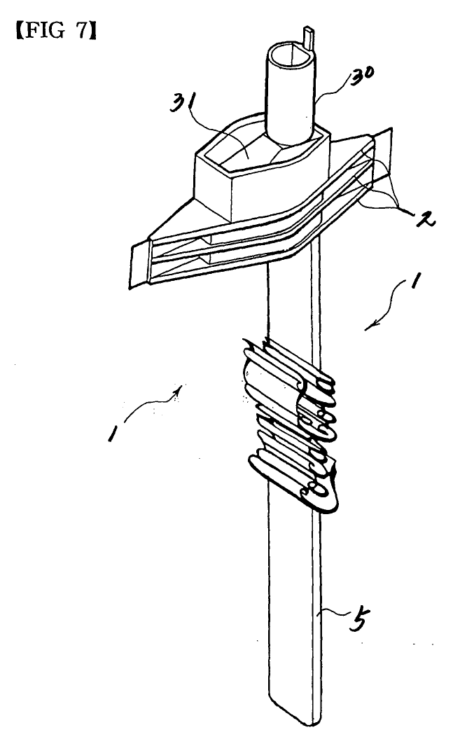

FIG. 7 shows a spout assembly according to a second embodiment of the present invention.

In this embodiment, the spout assembly has a spouting portion 30 that is capable of being bent.

That is, a bending guide portion 31 is formed on the spout-sealing portion 2 so that the spout-sealing portion 2 to be bent.

In this case, since the spouting portion is bent from a vertical state to a horizontal state, the space utilize can be improved.

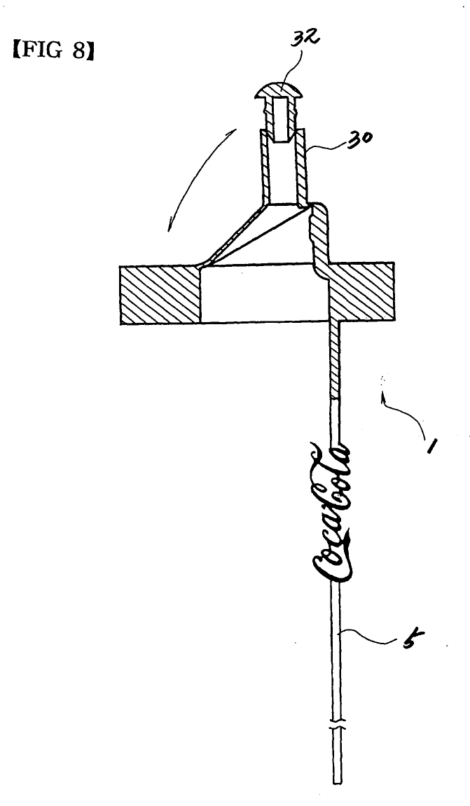

FIG. 8 is a modified example of FIG. 7, a cap 32 is integrally formed with the spouting portion.

In the above-described second embodiment, since other portions of the spout assembly are identical to those of the first embodiment, the detailed description of the same will be omitted herein.

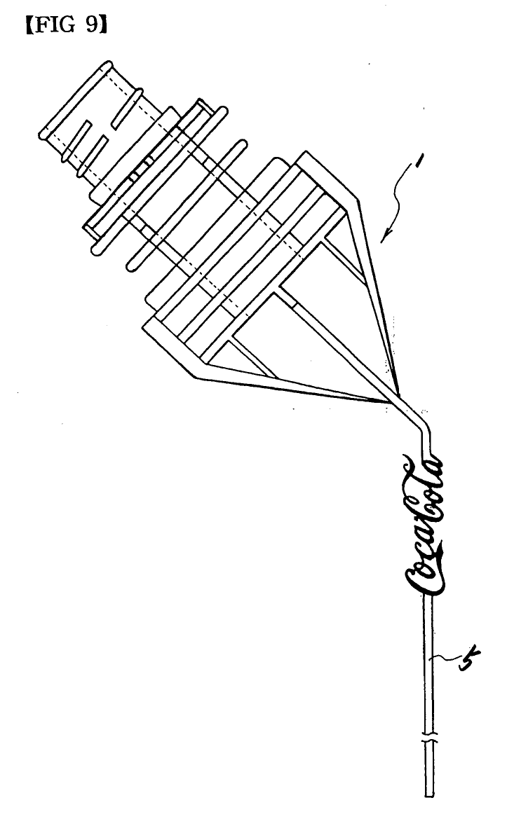

FIG. 9 shows a spout assembly according to a third embodiment of the present invention.

This embodiment is identical to the first embodiment except that the spouting guide portion 5 is formed to be bent at a predetermined angle.

When the spouting guide portion 5 is designed having the bending portion, the discharge of the content can be improved.

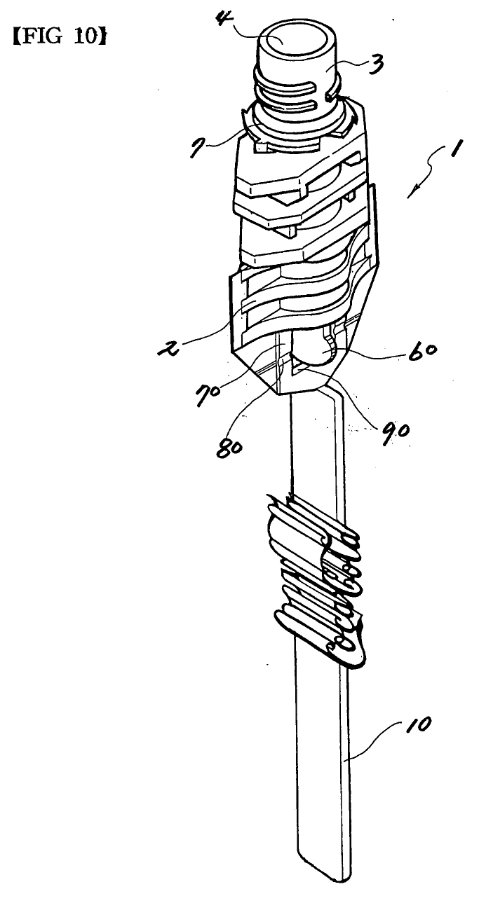

FIG. 10 shows a spout assembly according to a fourth embodiment of the present invention.

In this embodiment, the spout-sealing portion 2 is provided at its bottom with a circular fixing projection 60 selectively engaged with an operating projection 90. The operating projection 90 is supported by an operating projection-supporting portion 70 provided with a bending groove 80. The spouting guide portion 10 is formed extending under the operating projection 90.

Therefore, when the supporting portion 70 is bent through the bending groove 8, the operating projection 9 is engaged with the fixing projection 6 as it goes over a circular arc of the fixing projection 60, thereby maintaining the bending angle of the spout assembly 1.

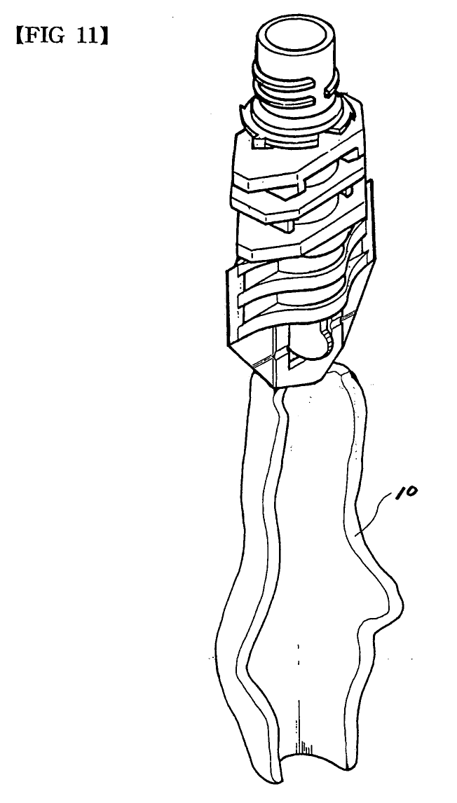

FIG. 11 is a modified example of FIG. 10, in which the spouting guide portion 5 is formed having a specific shape.

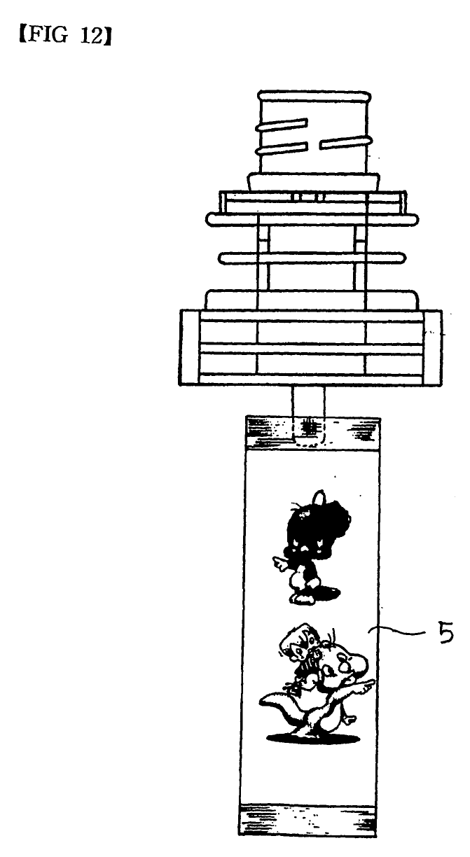

FIG. 12 shows a spout assembly according to a fifth embodiment of the present invention, in which characters functioning as the spouting guide portion is enclosed by an envelope 5′ so as to prevent the characters from directly contacting the content filled in the pouch container 100.

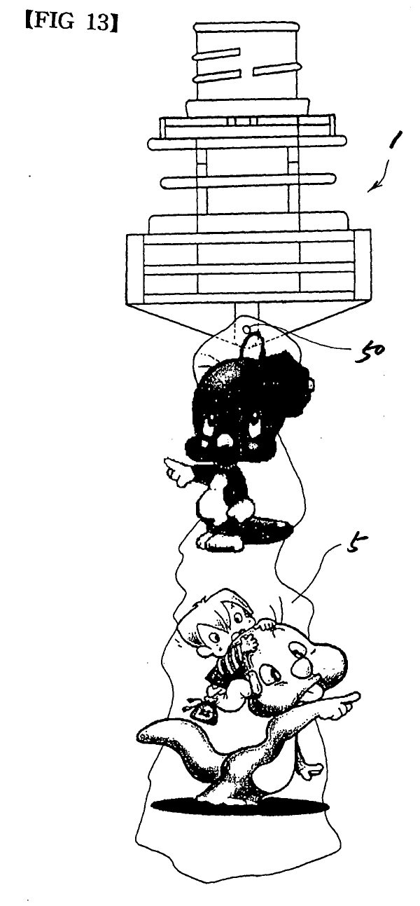

FIG. 13 shows a spout assembly according to a sixth embodiment of the present invention, in which a spouting guide portion provided with characters is pivotally coupled so that it can be moved by flowing force of contents or other outer force.

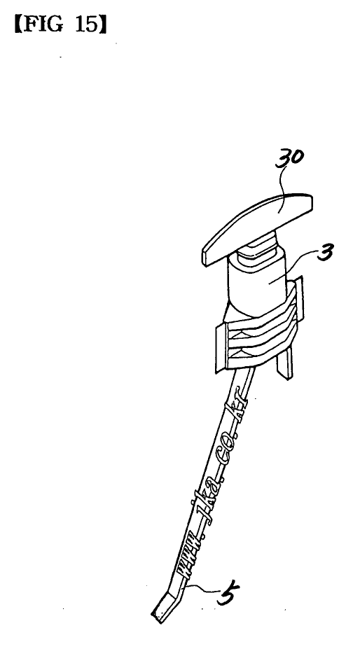

FIG. 15 shows a spout assembly according to a seventh embodiment of the present invention, in which the cap 30 is integrally formed with the spouting portion 3.

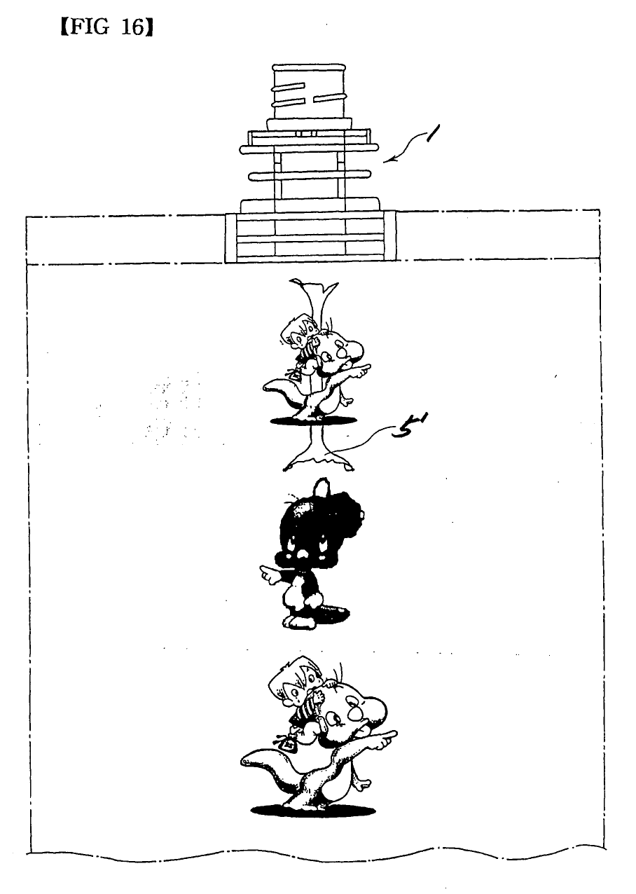

FIG. 16 shows a spout assembly according to an eighth embodiment of the present invention, in which the spouting guide portion of the spout assembly is separated into, for example, characters, and attached on an inner wall of the pouch container so that it can still function as a spouting guide portion.

### INDUSTRICAL APPLICABILITY

As described above, since a spout assembly is designed to be precisely and easily inserted into a pouch-sealing portion, the productivity is improved, while reducing the inferiority. In addition, since the spout assembly is designed having a specific shape capable of transferring a message or illustrating a characteristic of products where the spout assembly is applied, the overall esthetic sense of the products can be improved.

Furthermore, the spout assembly is “designed to be bent and” maintain its bending state, it is possible to stack the pouch containers to which the spout assembly is applied, thereby reducing the transportation costs and making it easy to display the containers.

1. A spout assembly for a pouch container, comprising:
a sealing portion to be sealed on the pouch container;
a spouting portion extending from the sealing portion upward, the spouting portion being provide with a spouting hole; and
a spouting guide portion extending from the sealing portion downward,
wherein the spouting guide portion comprises a specifically shaped portion that can represent a characteristic of a products and other information and improve an esthetic sense.

2. A spout assembly of claim 1 wherein the specifically shape portion is formed in at least one shape selected from the group consisting of letters, characters, miniatures, and logos.

3. A spout assembly of claim 1 wherein the spouting guide portion is integrally formed with the sealing portion.

4. A spout assembly of claim 1 wherein the spouting guide portion is separately formed and attached on an inner wall of the pouch container.

5. A spout assembly of claim 3 further comprising bending means for bending the spouting guide portion at a predetermined angle.

6. A spout assembly of claim 5 wherein the bending means comprises a fixing projection formed extending from the sealing portion, an operation projection selectively engaged with the fixing projection to maintain the bending angle of the spouting guide portion, and an operation projection supporting portion extending from the sealing portion to support the fixing projection.

7. A spout assembly of claim 1 further comprising an insertion guide portion formed under the sealing portion to guide the insertion of the sealing portion onto a pouch sealing portion of the pouch container.

8. A spout assembly of claim 7 wherein the insertion guide portion has a width that is reduced as it goes away from the sealing portion.

9. A spout assembly of claim 1 wherein the spouting guide portion is enclosed by a nontoxic envelope.

10. A spout assembly of claim 1 wherein a cap is integrally or separately formed on the spouting portion.

11. A spout assembly for a pouch container, comprising:
a sealing portion to be sealed on the pouch container;
a spouting portion extending from the sealing portion upward, the spouting portion being provide with a spouting hole; and
a spouting guide portion extending from the sealing portion downward,
wherein the spouting guide portion is designed to be bent at a predetermined angle by bending means.

12. A spout assembly of claim 11 wherein the spouting guide portion comprises a specifically shaped portion that can represent a characteristic of a products and other information and improve an esthetic sense.

13. A spout assembly of claim 12 wherein the specifically shape portion is formed in at least one shape selected from the group consisting of letters, characters, miniatures, and logos.

14. A spout assembly of claim 11 wherein the spouting guide portion is integrally formed with the spout-sealing portion.

15. A spout assembly of claim 12 wherein the spouting guide portion is separately formed and attached on an inner wall of the pouch container.

16. A spout assembly of claim 11 wherein the bending means comprises a fixing projection formed extending from the sealing portion, an operation projection selectively engaged with the fixing projection to maintain the bending angle of the spouting guide portion, and an operation projection supporting portion extending from the sealing portion to support the fixing projection.

17. A spout assembly of claim 11 further comprising an insertion guide portion formed under the sealing portion to guide the insertion of the sealing portion onto a pouch-sealing portion of the pouch container.

18. A spout assembly of claim 7 wherein the insertion guide portion has a width that is reduced as it gQes away from the sealing portion.
